(19) United States
(12) Patent Application Publication
(10) Pub. No.: US 2021/0116259 A1
(43) Pub. Date: Apr. 22, 2021

(54) ADAPTIVE TRANSIT RESOURCE ALLOCATION

(71) Applicant: Cubic Corporation, San Diego, CA (US)

(72) Inventors: Niosha Kayhani, Sutton (GB); Steffen Reymann, Guildford (GB)

(21) Appl. No.: 17/074,157

(22) Filed: Oct. 19, 2020

Related U.S. Application Data
(60) Provisional application No. 62/916,432, filed on Oct. 17, 2019.

(51) Int. Cl. G01C 21/36; G01C 21/34; H04W 4/029

(52) U.S. Cl. CPC G01C 21/362; G01C 21/3461; G01C 21/3691; H04W 4/029; G01C 21/3438; G01C 21/3415; G01C 21/3492

(57) ABSTRACT

A method of providing adaptive transit resource allocation may include receiving journey planning information from a mobile device. The method may include generating one or more routes based on the journey planning information. The method may include providing the one or more routes and details associated with each of the routes to the mobile device. The method may include receiving a selection of one of the one or more routes from the mobile device. The method may include analyzing the selection and selected routes from a number of other mobile devices. The method may include adjusting an allocation of transit resources based on the analysis.

### CROSS-REFERENCES TO RELATED APPLICATIONS

This application claims the benefit of priority to U.S. Provisional Patent Application No. 62/916,432 filed Oct. 17, 2019, entitled “ADAPTIVE ROAD PRICING,” the entire content of which is incorporated herein by reference for all purposes.

### BACKGROUND OF THE INVENTION

Currently, some municipalities and/or other traffic authorities have implemented road use charges, oftentimes as a mechanism to ease congestion in busy areas. Road use charging is currently done using automatic number plate recognition cameras. While this can be effective in some cases, such systems typically require a large amount of human oversight to ensure that the cameras have properly read and identified the number plates. Additionally, while conventional mapping services like Google Maps® provide great tools for planning a journey and the estimated time the journey would take, such mapping systems typically only account for current or predicted traffic levels and fail to factor in other variables that may affect a user's journey and/or external objective of the transit authority. Improvements in transit journey planning are therefore desired.

### BRIEF SUMMARY OF THE INVENTION

In one embodiment, a method of providing adaptive transit resource allocation is provided. The method may include receiving journey planning information from a mobile device. The method may include generating one or more routes based on the journey planning information. The method may include providing the one or more routes and details associated with each of the routes to the mobile device. The method may include receiving a selection of one of the one or more routes from the mobile device. The method may include analyzing the selection and selected routes from a number of other mobile devices. The method may include adjusting an allocation of transit resources based on the analysis.

In some embodiments, the journey planning information may include a time of the journey. Adjusting the allocation of transit resources may be further based on one or more policy objectives of a transit operator. The one or more policy objectives are selected from the group including reducing traffic congestion, encouraging rideshare usage, encouraging mass transit usage, reducing pollution, encouraging social distancing, routing traffic away from construction, routing traffic away from accidents, routing traffic away from schools, reducing an amount of traffic near a hospital, changing traffic based on weather patterns, and directing non-event traffic away from an event. Adjusting the allocation of transit resources may include adjusting a fare charge along one or more roads. The details associated with each of the routes may be based on one or more transit service statuses at a time of the journey. Adjusting the allocation of transit resources comprises placing additional transit vehicles into service. The method may include notifying the mobile device of a change in transit service status that impacts the selected route.

In one embodiment, a server for providing adaptive transit resource allocation is provided. The server may include a communications interface. The server may include a processor. The server may include a memory. The memory may have instructions stored thereon that, when executed, cause the processor to receive journey planning information from a mobile device, generate one or more routes based on the journey planning information, and provide the one or more routes and details associated with each of the routes to the mobile device. The instructions may cause the processor to receive a selection of one of the one or more routes from the mobile device, analyze the selection and selected routes from a number of other mobile devices, and adjust an allocation of transit resources based on the analysis.

In some embodiments, the instructions may further cause the processor to receive a verification indication from another mobile device that the mobile device and the another mobile device are on a same vehicle. The verification indication may include one or more of a radio frequency signal, an alphanumeric code, location information, or a machine-readable code. The instructions may further cause the processor to notify the mobile device of a change in transit service status that impacts the selected route. The instructions may further cause the processor to provide the mobile device with an alternative route while a user of the mobile device is traversing the selected route. The instructions may further cause the processor to receive location information associated with one or both of the mobile device and a vehicle associated with the mobile device and verify that the mobile device has completed a journey corresponding to the selected route based at least in part of the location information.

In one embodiment, a non-transitory computer-readable medium is provided. The computer-readable medium may have instructions stored thereon that, when executed, cause one or more processors to receive journey planning information from a mobile device, generate one or more routes based on the journey planning information, and provide the one or more routes and details associated with each of the routes to the mobile device. The instructions may cause the processor to receive a selection of one of the one or more routes from the mobile device, analyze the selection and selected routes from a number of other mobile devices, and adjust an allocation of transit resources based on the analysis.

In some embodiments, the instructions may further cause the one or more processors to lock in a journey cost for the selected route. The journey cost may be valid for a predetermined time window about a selected journey start time. Adjusting the allocation of transit resources may include opening express lanes to a particular direction of traffic flow. The instructions may further cause the one or more processors to notify the mobile device of a change in transit service status that impacts the selected route. The instructions may further cause the one or more processors to receive location information associated with one or both of the mobile device and a vehicle associated with the mobile device and verify the that mobile device has completed a journey corresponding to the selected route based at least in part of the location information.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a set of parentheses containing a second label that distinguishes among the similar components. If only the first reference label is used in the specification, the description is applicable to any one of the similar components having the same first reference label irrespective of the second reference label.

FIG. 1 illustrates a system for performing adaptive transit resource allocation according to some embodiments of the present invention.

FIG. 2 is a flowchart illustrating a process for journey planning according to some embodiments of the present invention.

FIG. 3 illustrates a road charge map according to some embodiments of the present invention.

FIG. 4 is a flowchart illustrating a process for operating an adaptive transit resource allocation system according to some embodiments of the present invention.

FIG. 5 is a flowchart illustrating a process for operating a mobile device in an adaptive transit resource allocation system according to some embodiments of the present invention.

FIG. 6 is a flowchart illustrating a process for providing adaptive transit resource allocation according to some embodiments of the present invention.

FIG. 7 illustrates a block diagram of a computer system according to some embodiments of the present invention.

### DETAILED DESCRIPTION OF THE INVENTION

Embodiments of the invention(s) described herein are generally related to a system and method of adaptive transit resource allocation. In particular, embodiments of the present invention are directed to systems and methods for operating an adaptive road pricing system that not only allows a traffic operator (such as a traffic authority of a municipality) to adjust transit operations to achieve various aims, but also provides routing options and general journey planning services to drivers based on the service status (detours, transit routes, tolls, congestion charges, adaptive speed limits, etc.) of various zones or routes. Embodiments, may allow the transit status to be adaptive to any number of variables and/or objectives (such as, but not limited to, pollution levels, traffic levels, weather, crowd levels, event data, time of day, day of week, accidents, construction, etc.), while allowing real-time status updates and/or service change notifications to be pushed in real-time or near real-time to affected users for possible rerouting to present users with one or more routing options. This allows the traffic authority to more effectively divert traffic, such as to ease congestion, direct traffic away from construction and/or an accident, and/or to reduce pollution in a particular area, while also ensuring that affected users may be effectively notified. Embodiments of the present invention may achieve the benefits above and others while requiring minimal infrastructure for road-user charging deployments. While discussed largely in the context of municipal traffic operations, a person of ordinary skill in the art will understand that alternative embodiments may vary from the embodiments discussed herein, and alternative applications may exist.

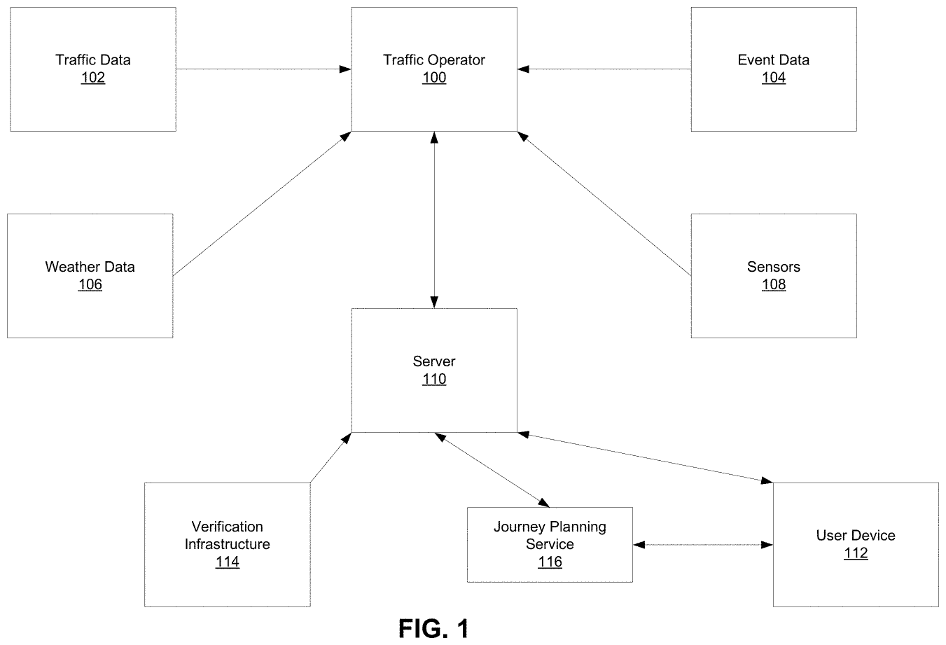

FIG. 1 is a system diagram of a system for operating an system for adaptive transit resource allocation according to one embodiment of the invention. The system may include a traffic operator 100, which may be, for example, a traffic authority of a municipality and/or other organization. The traffic operator 100 may include a computing device that is configured to determine proper allocation of transit resources based on one or more objectives. The transit operator 100 may further implement transit service changes to adjust current and/or future allocations of transit resources to achieve the desired objectives. For example, the transit operator 100 may allocate transit resources (such as activating express lanes, implementing detours, transit routes, tolls, congestion charges, adaptive speed limits, etc.) based on objectives such as, but not limited to, reducing traffic congestion, encouraging ridesharing and/or mass transit usage, reducing pollution, encouraging social distancing, reroute traffic away from construction and/or accidents, routing traffic away from schools when in session or during pickup and/or drop off periods, reduce the amount of traffic near a hospital, change traffic based on weather patterns, direct non-event traffic away from a large event that may cause congestion, and/or other objectives.

In order to automate the determination of current and/or future transit resource allocation to achieve one or more objectives, the traffic operator 100 may be coupled with one or more external data sources. For example, the traffic operator 100 may be in communication with a traffic data source 102 that may provide information related to current and/or predicted traffic flows along one or more roads within an area controlled by the traffic operator 100. The traffic information may be real-time traffic flow information received from one or more sensors positioned along a roadway and/or may include historical traffic data that may be used to predict traffic flows at similar times. In some embodiments where real-time traffic information is unavailable, including when planning for future resource allocation, the traffic data source 102 may provide historical traffic data and/or predictions of future traffic rates that are based on historical traffic data. The traffic operator 100 may use such information to, for example, divert traffic from congested areas to less utilized roadways by adjusting a service status of one or more roads. Transit data may also indicate the timing and/or location of construction projects and/or automobile accidents, which enables the transit operator 100 may adjust transit service status along one or more roads to direct traffic away from such locations.

The traffic operator 100 may be in communication with an event data source 104. The event data source 104 may provide the traffic operator 100 with information about events that may be taking place, including a time, location, date, expected crowd size, and/or other information associated with one or more events. The traffic operator 100 may use this information, for example, to divert traffic away from larger events at times near the scheduled beginning and/or end of the event. This may help ease congestion that will likely naturally occur given the large number of people who will be attending the event.

A weather data source 106 may provide weather information to the traffic operator 100. Good weather may encourage people to walk, ride bikes, etc., while cold weather and/or precipitation may cause more people to opt for vehicular transportation. The transit operator 100 may use such information, for example, to adjust a number of transit routes and/or transit vehicles in operation at a given time. The weather information may include current weather conditions and/or future forecast information.

In some embodiments, the traffic operator 100 may be in communication with one or more sensors 108. Sensors 108 may be used to provide data about any number of factors, possibly including some of the above, such as traffic data. The sensors 108 may also include pollution sensors that can detect measures of particulate in the air within a particular area and/or other measures of air quality. The sensors may also include temperature and/or pressure sensors. The transit operator 100 may use such information to reduce pollution in a particular area, such as by making service status adjustments that increase rideshare, mass transit, and/or non-automotive usage among users in the desired area.

It will be appreciating that directing traffic flow to or from a particular area to achieve various objectives may be performed by adjust numerous transit service statuses. For example, directing traffic flow may involve the transit operator 100 activating express lanes, implementing detours, implementing and/or adjusting transit routes, implementing and/or adjusting tolls, adjust transit fares, implementing and/or adjusting congestion charges, adjusting routes and/or numbers of in-service transit vehicles (or numbers of train cars of transit vehicles), implementing adaptive speed limits, etc.

The transit operator 100 may be in communication with one or more remote devices 112 (such as mobile phones, tablet computers, laptop computers, e-readers, etc.), which may allow transit service changes to be pushed out or otherwise communicated to users. For example, if a user is using a particular rideshare or transit vehicle, or has mapped out a particular trip, the transit operator 100 may send a notification to affected users' remote device 112 informing the user of the status changes. In some embodiments all users having a mobile application operated by the transit operator 100 may receive or otherwise access service updates, regardless of whether the user is affected by the changes. Such notifications may include basic data about the service changes and/or one or more alternative routing options that may better suit the needs of a given user. For example, when the transit operator 100 knows a given user is taking a particular route (which may be using rideshare, mass transit, and/or private car, etc.) the transit operator 100 may send the user customized routing options based on any service changes that may affect the user's route.

In some embodiments, the transit operator 100 may be interfaced with and/or operate a journey planning service 116. While described as a separate component, it will be appreciated that in some embodiments the functionality described in relation to the journey planning service 116 may be performed by the transit operator. Journey planning service 116 may be accessed by users via remote devices 112 and may enable the users to plan routes for a given trip or journey, both current and future, and may factor in service statuses of various roads and/or routes (which may include one or more different roads). The trips may be completed using one or more modes of transportation, including walking, scooters, bikes, motor vehicles, public transit, rideshares, watercraft, aircraft, and the likes. The journey planning may provide the users information related to the transit service statuses, allowing users to select journey routes that correspond to routes that meet the particular criteria most important to a given user. For example, a user may want to select a route for a given journey based on least total mileage, expected fuel cost (which may require the user to input specific vehicle information), shortest total time, routes that avoid construction, toll roads, highways, etc., lowest total cost, fewest vehicle changes, fewest transit stops (express vs. regular routes, etc.) and/or other criteria. The various criteria may be impacted by various transit service statuses. For example, information about express lane status, known detours, transit routes, transit fare prices, congestion charges, adjusting routes numbers of in-service transit vehicles (or numbers of train cars of transit vehicles), speed limits, and/or other status information may impact the criteria selected by a user and change what route a user may wish to take. Transit status information may be based on real-time and/or otherwise current status information provided to the transit operator 100 and/or journey planning service 116 by various entities, such as those described above and/or may be based on predicted statuses that may be based on historical data and/or reliable future data (such as weather, pollution, traffic, event data, and the like).

The various components of the system may be in direct communication with the transit operator 100 and/or may be in communication with the transit operator 100 via a server 110. Server 110 may be a part of a system of the traffic operator 100 and/or may be a separate device and/or entity. It will be appreciated that the various functionality of the traffic operator 100 may be performed by the server 110 and/or journey planning service 116, and vice versa. In some embodiments, the functionality of the transit operator 100, journey planning service 116, and/or server 110 may be combined into a single device or entity.

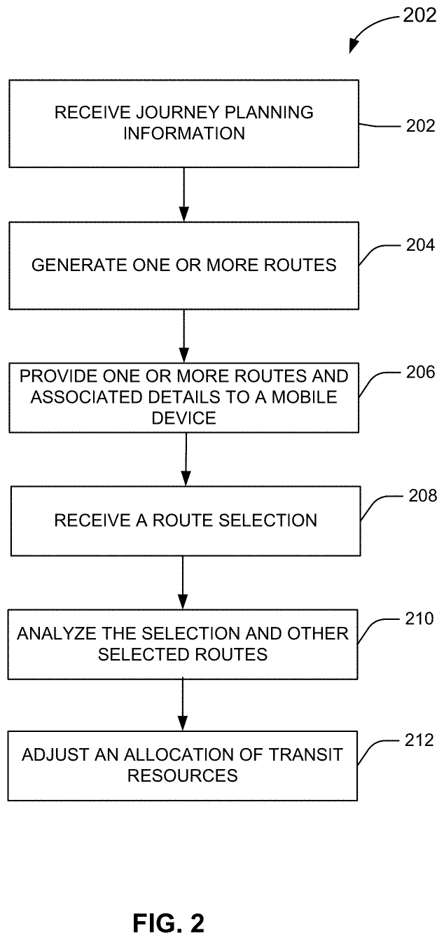

FIG. 2 illustrates one embodiment of a process 200 for journey planning, which may be performed using the system of FIG. 1. To commence journey planning, the user may use his remote device 112 to interact with the journey planning service 116, such as through a website and/or mobile application. The user may provide route information to the journey planning service 116. For example, the journey planning service 116 may receive journey information at operation 202, such as an origin, destination, and/or desired path of travel from a remote device 112 (such as a tablet computer, mobile phone, etc.). For example, the remote device 112 may allow a user to select a route by drawing, using a map service, selecting an origin and/or destination, and/or otherwise inputting the route into a mobile application and/or website being accessed via the remote device 112. The journey information may include a time of travel and/or a duration of a stay in one or more location along the route (such as how long the user intends to stay at a destination in the event of a round trip journey, as just one example). The journey information may include route criteria selected by the user (such as lowest mileage, shortest travel time, etc. as described above). In some embodiments, a user may not specify criteria and a default set of criteria may be utilized. Once the journey information is received, the journey planning service 116 may generate at operation 204 and provide one or more route options to the user at operation 206. If more than one route is presented, the routes may be sorted based on which route most closely matches the criteria. Details associated with each route, such as total mileage, expected fuel cost, shortest total time, whether there is construction and/or accidents on the route, whether the route involves toll roads, highways, etc., a total journey cost, number of transit stops, number of vehicle changes, and/or other information may be provided to the user. The various details may be based on transit service statuses at the time of the journey (current or predicted future statuses). In embodiments where the user inputs an actual route himself, the journey planning service 116 may provide details associated with the selected route. In some embodiments, one or more alternative route options may also be provided to the user based on one or more criteria. In some embodiments, the criteria may be based on the particular user's previous route selections (e.g., if the user typically has chosen the fastest or least cost route, the journey planning service 116 may suggest an alternate route that may be faster and/or cheaper than the route originally selected by the user) based on default settings, and/or based on the transit operator's 100 desired objectives (e.g., reducing pollution and/or congestion in a particular area).

The user may view the route options on the remote device 112 and may select a particular route, which may be received by the journey planning service at operation 208. In some embodiments, the selection of a given route may involve the user booking one or more legs of the journey on a rideshare or transit vehicle. In some embodiments, one or more legs of the journey may be completed in a private vehicle. This information may be provided to the transit operator 100. Based on the selected journeys of a number of users, the transit operator 100 may adjust the allocation of transit resources to meet the needs of the various users and/or to meet objectives of the transit operator 100. For example, the transit operator 100 may analyze the selected journey at operation 210 and determine allocation of resources based on the analysis at operation 212. As one example, if the aggregated journey selections indicate a large number of people using a particular route or road within a route, the transit operator 100 may make adjustments to compensate. As just one example, additional transit vehicles (or train cars) may be put into service to accommodate increased ridership. Speed limits may be adjusted to ensure smooth traffic flow and/or reduce the likelihood of accidents, express lanes may be opened up in a particular direction of traffic flow, and/or more traffic officers may be sent out. In some embodiments, as more users indicate they will be traveling along a particular route, the service status adjustments may involve the transit operator 100 implementing and/or adjusting tolls, congestion charges, and/or other road charges to encourage people to take alternative routes and/or discourage people from taking particular routes. For example, to discourage additional people from using a particular route, a road charge or toll may be raised or implemented, while alternative roads may have cheaper charges (or zero charges). While these alternative roads may be slower or involve greater mileage, people may be persuaded to use the alternative roads and/or routes based on the lower cost associated therewith. In some embodiments, rather than (or in addition to) using such road charge techniques to reduce traffic congestion, such charge techniques may be used to achieve other policy objectives of the transit operator 100, such as reducing pollution in a given area (higher charges in areas in which pollution needs to be reduced), divert traffic away from an event, school, hospital, construction, accident, etc., reducing crowd levels in a particular area, increasing transit system ridership, and/or other policy objectives.

In some embodiments, the adjustments to transit resources that involve service status changes may affect the details associated with a particular route. In some embodiments, the journey planning service 116 may provide one or more users (possibly just those users affected by the changes) with information associated with the service status changes. For example, if adaptive speed limits along a selected route are adjusted, the users may be notified on the remote devices 112 of the change in status, along with the change in duration of the trip. In some embodiments, the journey planning service 116 may provide one or more alternate routes that may be more appealing to the user based on the service status change and/or other adjustment to transit resources.

In one particular embodiment, the journey planning service 116 may be configured to suggest routes based on the criterion of lowest cost route. In such an embodiment, the journey planning service 116 may receive journey information as described above. When generating one or more routes for the journey, the journey planning service 116 may access current charge data for one or more roads (or portions thereof) along each potential route. The journey planning service 116 may then provide routes to the users based on a total cost of each of the roads along a given route (which may be zero in some instances), allowing the users to select the lowest cost route (or at least providing the users with information about the cost of a journey such that the user may factor in this information when determining which route to select). Other details associated with each route may also be provided to the user as described above.

The road charge data may be generated by the transit operator 100 based on any number of objectives as discussed above. For example, to reduce traffic, crowding, and/or pollution in a given area (or to increase transit ridership), the transit operator may implement and/or increase road charges along one or more roads of a given route to discourage users to take the designated roads. The charges associated with alternate roads may be reduced and/or eliminated to encourage people to take the alternate routes. The pricing may be dynamic, and may fluctuate constantly, at predetermined intervals, and/or based on shifts in various factors (such as traffic levels, pollution levels, upcoming or current events, construction, accidents, etc.) to enable the transit operator 100 to dynamically tailor charges to achieve a given set of objectives and/or to help the transit operator 100 more easily allocate transit resources. It will be appreciated that the use of road charges may be implemented alone or in conjunction with other transit service status changes (such as those discussed above) to meet the objectives of a transit operator 100. The journey planning service 116 may calculate an estimated cost based on the desired route, traffic conditions (real-time and/or predicted), and the charge information. The estimated costs associated with the desired route may be provided to the mobile device. In some embodiments, one or more alternate routes may also be provided to the mobile device, with each route having its own duration, distance, cost, etc.

In some embodiments, the user may be able to lock in a given cost for a journey. For example, in some instances, at the time of journey planning, the user may lock in a selected route at the price indicated by the journey planning service 116. In such instances, the user may be given a window (such as within 30 minutes of the time indicated in the journey information) in which to begin the journey to keep the locked-in journey cost. If the user fails to start the journey within the given window, the user may forfeit the locked-in journey cost and may be subject to updated charges, which may be higher or lower depending on the current conditions (traffic levels, pollution levels, upcoming or current events, construction, accidents, etc.) and/or new traffic operator objectives. In other embodiments, the user may lock-in a price as soon as the user begins a journey.

To ensure that users follow the designated rate, and thus get charged appropriately, the journey planning service 116 may monitor the location of each user along the journey. For example, location data from the mobile device and/or received from one or more sensors that detected a route of the mobile device and/or a vehicle associated with the mobile device (such as wireless beacons may be provided to the journey planning service 116. For example, the system may also include verification infrastructure 114 that may communicate with the server 110 and/or remote device 112 to determine an actual path traveled by the remote device 112 and consequently, how much an account associated with the remote device should be charged based on time and/or distance spent within one or more charge zones. The verification infrastructure 114 may include beacons in communication with remote device 112 and/or a vehicle that is associated with the remote device 112 (such as via an enrollment process), cameras that may track the position of the vehicle (such as plate recognition cameras), tollway transponders, and/or other data-gathering systems. In some embodiments, the verification infrastructure 114 may include the server 110. For example, the server 110 may receive time and location information (such as from a GPS unit, via triangulation of a cell signal, etc.) from the remote device 112 and/or a vehicle associated with the remote device 112. The server 110 may take in the time and location information and determine whether the user stayed on the selected route and/or to determine how much the account associated with the remote device 112 should be charged and may debit payment (or cause another entity to debit payment) from the user's payment account.

Embodiments may include an associated mobile application that allows operators to communicate these changes to riders and drivers and for riders and drivers to plan and estimate the cost of their journey. The mobile application may also functions based on proximity to allow ride-sharing i.e. two people in close proximity can use NFC, BLE, barcode, and/or other code that verifies their proximity and therefore enables the charges to be reduced as they are ride-sharing. In some embodiments, the mobile application includes an offline mode that uses WiFi and/or Bluetooth to aid position coordinates. Embodiments of the invention may perform a payment calculation based on distance and/or time within one or more charging zones. This calculation may be performed by a cloud server in some embodiments.

In some embodiments, the transit operator 100 and/or journey planning service 116 may offer users reduced charges to utilize the journey planning service 116. This may increase participation in the journey planning service 116, while may lead to the transit operator 100 having access to a larger and more accurate data pool to analyze in order to properly allocate transit resources and to make adjustments to service statuses to achieve desired objectives.

In some embodiments, the traffic operator 100 may decide to offer reduced charges to users participating in a rideshare program, such as by carpooling. In such instances, the remote device 112 may alert the server 110 that the remote device 112 is being used in a rideshare journey. The server 110 may require verification that the remote device 112 is actually on a same vehicle as another remote device that is being used to pay for the rideshare journey. Users of the remote devices 112 may use close range verification means from the mobile application to provide the server 110 with assurance that the remote devices 112 are on the same vehicle. For example, an exchange of data via a short range communication technique (BLE, NFC, entering and/or scanning a code from the opposite remote device 112, etc.) between the mobile applications on remote devices 112 may be used as proof that the remote devices 112 are traveling together. In other embodiments, location information from a vehicle and/or one or both remote devices 112 may be compared to one another to determine that the remote devices 112 are on the same vehicle. In some embodiments, short range verifications may be performed continuously and/or periodically to ensure that the remote devices 112 are still on the same vehicle. Once the rideshare has been verified, the accounts associated with the remote devices 112 may be provided discounted rates for all or part of their journey (such as a portion of the journey that the remote devices 112 were present on the same vehicle). The ride-sharing feature helps the traffic operator 100 by reducing the volume of traffic (and therefore emissions) while helping the individual users by reducing road user charge pricing.

In some embodiments, changes in the charges may occur during or just before a user's journey. The journey planning service 116 may provide updated charge data to the remote device 112 once the data is available. In some embodiments, a user en route may be notified if a selected route has charges increased (or if an alternate route becomes cheaper for any reason). In some embodiments, once a user begins a journey, leg of a journey, and/or locks in a cost for the leg and/or journey, the user may not be charged higher amounts if the charges are increased. However, such users may be notified if an alternate route is made cheaper. For example, rather than charging users who have locked in rates or otherwise begun their journey increased rate to achieve a particular objective, the transit operator 100 may reduce the cost of an alternate path in order to encourage the users to take a different route. In such instances, the transit operator 100 may communicate a suggested cheaper alternate route to one or more users. If a user wishes to select the cheaper route, the server 110 and/or a website or mobile application operated by the server 110 (and/or transit operator 100 and/or journey planning service 116) may send the new route to the user, which may involve sending an instruction that causes a GPS or other mapping application to reroute to the alternate route. Similar rerouting may be pushed out if other service statuses are made, such as speed limit changes, construction commencement, occurrence of a traffic accident, etc.

In some embodiments, the traffic operator 100 may continually update the charges and provide this information to the server 110, which may then pass charge data to a number of remote user devices 112, such as by providing the information to a mobile application and/or website being accessed via the user devices 112. The server 110 may receive route information, such as an origin, destination, and/or desired path of travel from a remote device 112 (such as a tablet computer, mobile phone, etc.). For example, the remote device 112 may allow a user to select a route by drawing, selecting an origin and/or destination, and/or otherwise inputting the route into a mobile application and/or website being accessed via the remote device 112. This route information may be passed to the server 110, which may calculate an estimated travel cost. For example, the estimated travel cost may be based on the particular route chosen, road charges associated with the journey, and/or an expected time to be spent on each road (or portion thereof) associated with a charge. The time spent on each road (or portion thereof) may be based on factors such as posted speed limit, current and/or expected traffic conditions, distance, etc. The estimated cost may be passed down to the remote device 112 such that the user may determine whether to proceed with the particular route. In some embodiments, the server 110 may provide one or more alternate routes to the remote device 112 that may include higher and/or lower estimated costs, different travel times, etc. The estimated cost and/or alternate routes may be presented on a display of the remote device 112 such as in map form and/or a quick description of the route, cost, and/or travel time associated with a given route.

In some embodiments, rather than having the server 110 calculate the estimated cost, the mobile application of the remote device 112 may be provided with sufficient information (charge zone information, traffic information, routing options, etc.) to generate its own estimated costs and/or alternate routes, such as when integrated into an offline version of a mapping application.

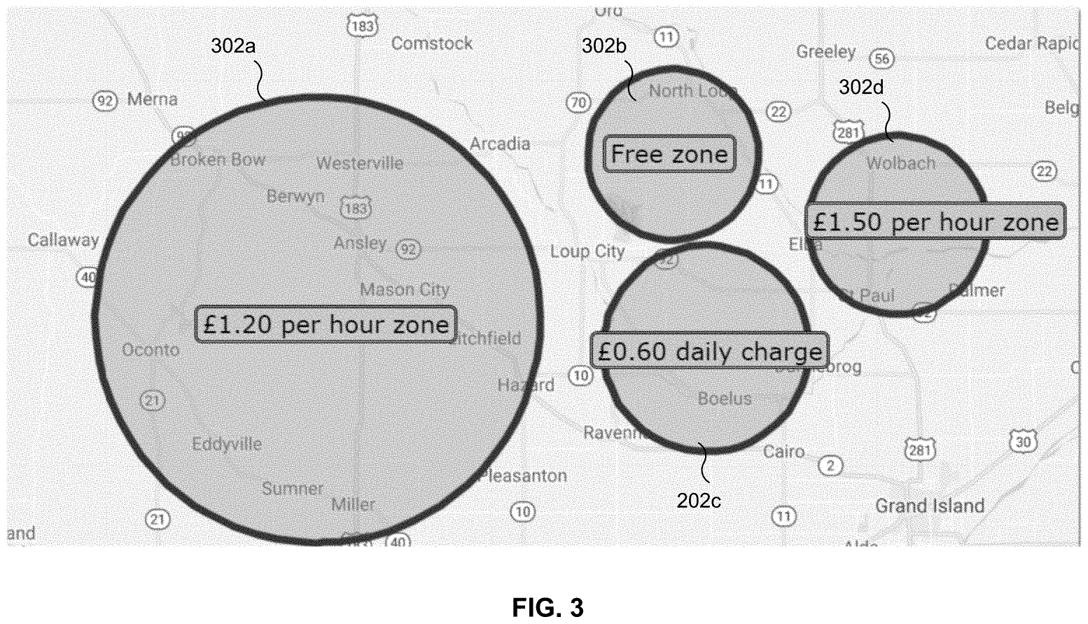

In some embodiments, rather than, or in addition to, using charges associated with particular roads (or portions thereof), the transit operator 100 may create adaptive geo-fenced zones for charging motor vehicles based on distance and/or time spent within the geo-fenced zones. At the same time, embodiments allow users to plan a journey and use a mapping system that estimates the journey time as well as a time spent in each geo-fenced zone. This data is aggregated to calculate an estimated cost for a journey. In some embodiments, the price set by operators may be set automatically according to various rules and/or goals. For instance, the zone creation and/or pricing may be linked to local air pollution data, local event data, school/holiday schedules, etc. FIG. 3 illustrates one embodiment of a road charge map 300. Here, map 300 includes four road charge zones 302, although it will be appreciated that other embodiments may have more or fewer (and even none) charge zones 302 at any given point. Charge zones 302 may be determined based on any criteria and may include boundaries, such as geo-fence boundaries that determine where a user begins to be charged. The charges zones 302 may have different mechanisms for payment. As illustrated here, a charge zones 302a and 302d charge based on an hourly rate, while charge zone 302c charges per day. Charge zone 302b provides free travel, although in some embodiments the charge-free zones may be unmarked. Oftentimes, a traffic operator will increase the rate and/or overall cost associated with traveling in a particular zone to dissuade people from taking a particular route. While illustrated as being circular, it will be appreciated that charge zones 302 may have any shape and/or size. In some embodiments, a charge zone 302 may include only a single road/route.

Oftentimes, the charge zones 302 may be presented on a map that is viewable via a mobile application and/or website accessed via a computing device, such as a laptop, tablet, mobile phone, etc. This allows a user to quickly view and analyze the locations of the charge zones 302 during journey planning. The charge zones 302 may be static and/or may evolve based on a desire to achieve a certain goal, such as, but not limited to, reducing congestion and/or pollution near a certain area. The charge zones 302 may be updated in real-time. Oftentimes, a user who is in a charge zone 302 when the zone is updated will be provided with the lowest cost associated with the charge zone 302 during his stay within the zone. In some embodiments, the charge associated with a particular charge zone 302 may be based on a status of the user entering the zone. For example, a solo traveler, a rideshare user, and/or a commercial driver may have different pricing associated with a particular charge zone 302. It will be appreciated that for the purposes of the present application, the terms road charge and charge zone may be used interchangeably.

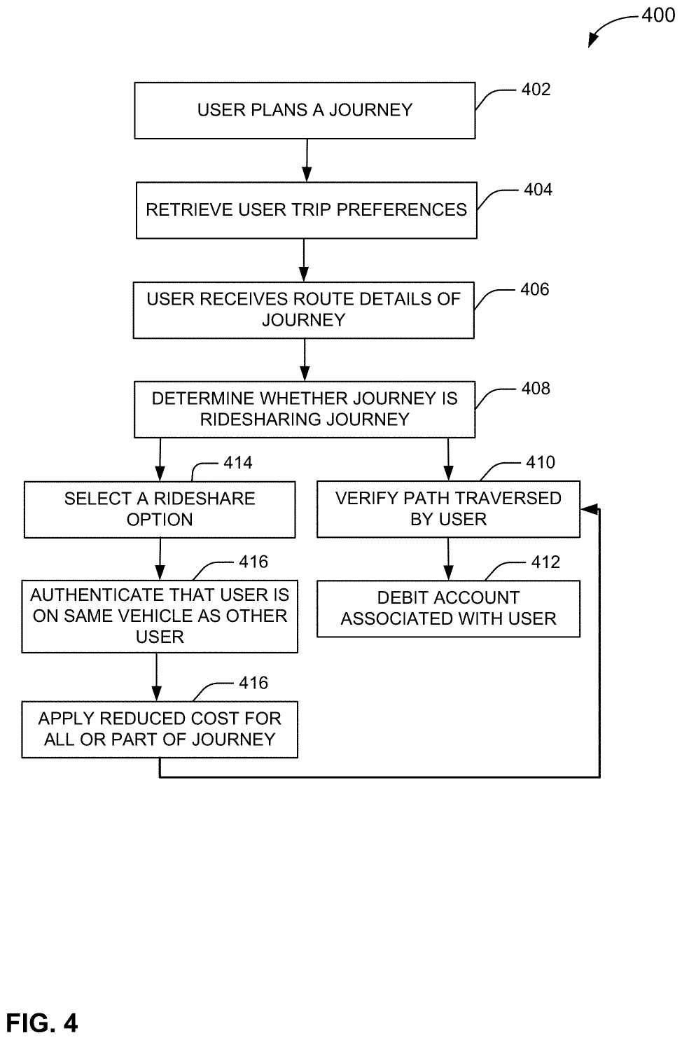

FIG. 4 is a flowchart of a process 400 for operating an adaptive transit resource allocation system according to one embodiment of the invention. Process 400 may include a traffic operator setting up one or more road charges based on various criteria. In some embodiments, the road charge may be for a full road, a portion of a road, and/or a charge zone. Each zone may be defined by a size, location, cost, and/or other feature. The various charges may be pushed out to users. For example, a server (such as server 110) may receive the zone information from the traffic operator and provide the zone information to one or more users via a mobile application being executed by their respective mobile devices. A user may plan a journey at block 402 by inputting a route, origin, destination, time of day, etc. into the mobile application. In some embodiments, the user may have preferences such as a cheapest route, shortest distance, parking costs, quickest route, etc. Oftentimes, these may be pre-set preferences that may be retrieved at block 404, while in other embodiments, this data may be input by the user at the time of journey planning.

The user receives route details, which may include a total time, total mileage, total cost, etc., at block 406. In some embodiments, the estimated cost may be provided to the user by a server that receives the user's journey planning information and any preferences and calculates the estimated cost based on factors such as road charges, traffic, distance, etc. In other embodiments, the user's mobile device may calculate the estimated cost based on similar information. In some embodiments, one or more alternative routes may also be provided to the user. The alternative routes may be associated with lower costs, shorter travel times, shorter distances, etc. In some embodiments, any routes provided to the user may be provided in the form of a map that is displayed on the user's mobile device.

After a journey is planned, a determination is made as to whether the journey is a ride sharing journey at block 408. If not, the server may verify an actual path traversed by the user (such as by tracking a vehicle and/or mobilize device associated with the user as described above) at block 410 and may then debit an account associated with the user at block 412. If the journey is a ride sharing journey, the process 400 may include the user interacting with the mobile application (or a separate mobile application) to selected a rideshare option at block 414. The user must then authenticate that he is in the same vehicle as another rideshare user at block 416. This may be done, for example, via short range communications exchanged between the users' devices and/or by comparison of location information. In other embodiments, a vehicle system may ensure that the user is present, such as via a biometric scan and/or authentication by entry of a code into one or both of the vehicle system or the mobile device, with the code being displayed on the other device. Once verified, the server may apply a reduced cost for all or part of the journey at block 418 before debiting the account associate with the user at block 412.

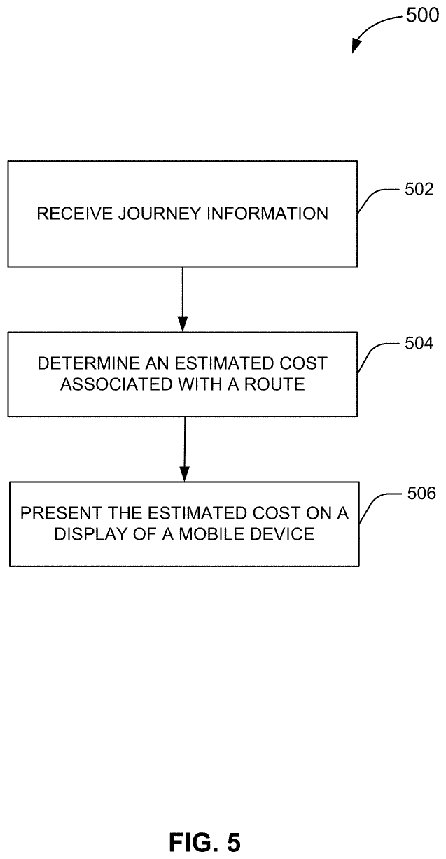

FIG. 5 is a flowchart of a process 500 for operating a mobile device in an adaptive transit resource allocation system. Process 500 may be performed using a mobile device, such as remote device 112 and/or other mobile communications device. At block 502, the mobile device may receive journey information. For example, a user may draw, select, and/or otherwise input a route, destination, origin, and/or expected time of travel into a mobilize application being executed on the mobile device. This journey information may be used to generate one or more routes and route details, including total time, total mileage, and/or total cost, etc., at block 504. For example, in some embodiments the journey information may be sent to a server that generates the details and sends the details back to the mobile device for presentation to the user. In other embodiments, the mobile device may receive traffic information (real-time and/or predicted) and/or other information (accidents, construction, current speed limits, road charges, etc.) which may be used along with the journey information to generate an expected duration and/or cost of the journey. Once determined, these details may be presented on a display of the mobile device at block 506. In some embodiments, one or more additional routes with associated details (such as mileage, duration, costs, etc.) may also be provided to the mobile device. In some embodiments, the mobile device may further provide current location information and/or otherwise interact with sensors coupled with a server to allow the server to determine the mobile device's actual journey path (which may vary from the route associated with the estimated cost). The server may then calculate an actual cost associated with the final route and debit an account associated with the mobile device.

In some embodiments, the user of the mobile device may wish to take advantage of a rideshare program for reduced charge zone rates. In such embodiments, the process 500 may also include receiving a verification indication from another mobile device that the mobile device and the additional mobile device are on a same vehicle. For example, the verification indication may include a radio frequency signal, an alphanumeric code, location information, and/or a machine-readable code.

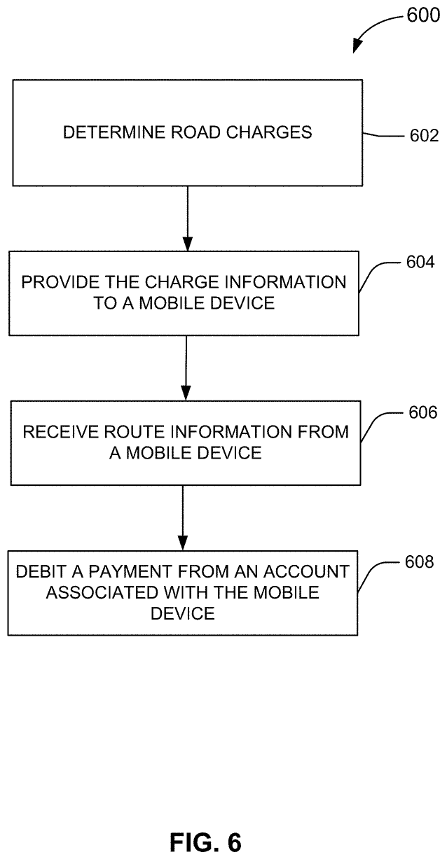

FIG. 6 illustrates an embodiment of a process 600 for providing adaptive transit resource allocation. Process 600 may be performed by a server, such as server 110. Process 600 may begin at block 602 by determining road charges within a traffic system. For example, a charge associated with each of a number of roads, portions of roads, and/or charge zones may be determined. The boundaries and/or charges may be generated automatically by the server based on one or more considerations (e.g., reduce congestion, avoid construction, etc.) and/or may be provided to the server by a traffic operator. Once determined, the charges may be provided to a mobile device at block 604. For example, the charge information, possibly in the form of a map, may be sent to a mobile application being executed on the mobile device.

Route information may be received from the mobile device at block 606. For example, location data from the mobile device and/or received from one or more sensors that detected a route of the mobile device and/or a vehicle associated with the mobile device may be provided to the server. The route information may be used by the server to calculate a cost of the route traversed by the mobile device. The cost may be based on a time and/or distance within a particular road charge. At block 608, a payment may be debited from an account associated with the mobile device based on calculated cost.

In some embodiments, the server may also provide a cost estimate to the mobile device as part of a journey planning process. For example, the server may receive journey planning information that includes a desired route from the mobile device. The server may calculate an estimated cost based on the desired route, traffic conditions (real-time and/or predicted), and the charge zone information. The estimated costs associated with the desired route may be provided to the mobile device. In some embodiments, one or more alternate routes may also be provided to the mobile device, with each route having its own duration, distance, cost, etc. In some embodiments, changes in the charge zones may occur during or just before a user's journey. The server may provide updated charge zone data to the mobile device once the data is available. In some embodiments, a user en route may be notified if a selected route has charges increased (or if an alternate route becomes cheaper for any reason).

In some embodiments, the server may receive an indication that a user associated with the mobile device is participating in a rideshare program. In such embodiments, the server may verify that the mobile device is present in a same vehicle as an additional mobile device that is participating in the rideshare program. This may be done, for example, by receiving an indication from a vehicle system, the mobile device, and/or the additional mobile device that the two devices are within close proximity and traveling together as described above. Upon verification, an estimated cost of at least a portion of the desired route may be determined based on a rideshare program rate.

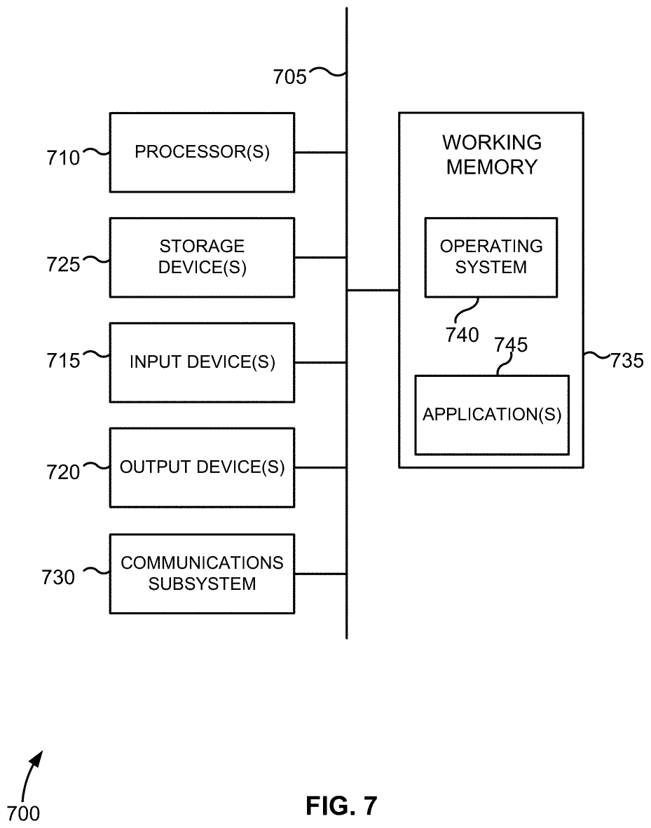

A computer system as illustrated in FIG. 7 may be incorporated as part of the previously described computerized devices. For example, computer system 700 can represent some of the components of computing devices, such as traffic operator 100, server 110, journey planning service 116, verification system 114, remote device 112, and/or other computing devices described herein. FIG. 7 provides a schematic illustration of one embodiment of a computer system 700 that can perform the methods provided by various other embodiments, as described herein. FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include a processing unit 710, including without limitation one or more processors, such as one or more special-purpose processors (such as digital signal processing chips, graphics acceleration processors, and/or the like); one or more input devices 715, which can include without limitation a keyboard, a touchscreen, receiver, a motion sensor, a camera, a smartcard reader, a contactless media reader, and/or the like; and one or more output devices 720, which can include without limitation a display device, a speaker, a printer, a writing module, and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 700 might also include a communication interface 730, which can include without limitation a modem, a network card (wireless or wired), an infrared communication device, a wireless communication device and/or chipset (such as a Bluetooth™ device, an 502.11 device, a Wi-Fi device, a WiMAX device, an NFC device, cellular communication facilities, etc.), and/or similar communication interfaces. The communication interface 730 may permit data to be exchanged with a network (such as the network described below, to name one example), other computer systems, and/or any other devices described herein. In many embodiments, the computer system 700 will further comprise a non-transitory working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 710, applications 745, etc.) Further, connection to other computing devices such as network input/output devices may be employed.

Some embodiments may employ a computer system (such as the computer system 700) to perform methods in accordance with the disclosure. For example, some or all of the procedures of the described methods may be performed by the computer system 700 in response to processing unit 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processing unit 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processing unit 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 725. Volatile media include, without limitation, dynamic memory, such as the working memory 735. Transmission media include, without limitation, coaxial cables, copper wire, and fiber optics, including the wires that comprise the bus 705, as well as the various components of the communication interface 730 (and/or the media by which the communication interface 730 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a non-transitory storage device 725 either before or after execution by the processing unit 710.

In the embodiments described above, and in the attached Appendix, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method of providing adaptive transit resource allocation, comprising:
receiving journey planning information from a mobile device;
generating one or more routes based on the journey planning information;
providing the one or more routes and details associated with each of the routes to the mobile device;
receiving a selection of one of the one or more routes from the mobile device;
analyzing the selection and selected routes from a number of other mobile devices; and
adjusting an allocation of transit resources based on the analysis.

2. The method of providing adaptive transit resource allocation of claim 1, wherein:
the journey planning information comprises a time of the journey.

3. The method of providing adaptive transit resource allocation of claim 1, wherein:
adjusting the allocation of transit resources is further based on one or more policy objectives of a transit operator.

4. The method of providing adaptive transit resource allocation of claim 3, wherein:
the one or more policy objectives are selected from the group comprising:
reducing traffic congestion, encouraging rideshare usage, encouraging mass transit usage, reducing pollution, encouraging social distancing, routing traffic away from construction, routing traffic away from accidents, routing traffic away from schools, reducing an amount of traffic near a hospital, changing traffic based on weather patterns, and directing non-event traffic away from an event.

5. The method of providing adaptive transit resource allocation of claim 1, wherein:
adjusting the allocation of transit resources comprises adjusting a fare charge along one or more roads.

6. The method of providing adaptive transit resource allocation of claim 1, wherein:
the details associated with each of the routes are based on one or more transit service statuses at a time of the journey.

7. The method of providing adaptive transit resource allocation of claim 6, wherein:
adjusting the allocation of transit resources comprises placing additional transit vehicles into service.

8. The method of providing adaptive transit resource allocation of claim 1, further comprising:
notifying the mobile device of a change in transit service status that impacts the selected route.

9. A server for providing adaptive transit resource allocation, comprising:
a communications interface;
a processor; and
a memory having instructions stored thereon that, when executed, cause the processor to:
receive journey planning information from a mobile device;
generate one or more routes based on the journey planning information;
provide the one or more routes and details associated with each of the routes to the mobile device;
receive a selection of one of the one or more routes from the mobile device;
analyze the selection and selected routes from a number of other mobile devices; and
adjust an allocation of transit resources based on the analysis.

10. The server for providing adaptive transit resource allocation of claim 9, wherein the instructions further cause the processor to:
receive a verification indication from another mobile device that the mobile device and the another mobile device are on a same vehicle.

11. The server for providing adaptive transit resource allocation of claim 10, wherein:
the verification indication comprises one or more of a radio frequency signal, an alphanumeric code, location information, or a machine-readable code.

12. The server for providing adaptive transit resource allocation of claim 9, wherein the instructions further cause the processor to:
notify the mobile device of a change in transit service status that impacts the selected route.

13. The server for providing adaptive transit resource allocation of claim 12, wherein the instructions further cause the processor to:
provide the mobile device with an alternative route while a user of the mobile device is traversing the selected route.

14. The server for providing adaptive transit resource allocation of claim 9, wherein the instructions further cause the processor to:
receive location information associated with one or both of the mobile device and a vehicle associated with the mobile device; and
verify that the mobile device has completed a journey corresponding to the selected route based at least in part of the location information.

15. A non-transitory computer-readable medium having instructions stored thereon that, when executed, cause one or more processors to:
receive journey planning information from a mobile device;
generate one or more routes based on the journey planning information;
provide the one or more routes and details associated with each of the routes to the mobile device;
receive a selection of one of the one or more routes from the mobile device;
analyze the selection and selected routes from a number of other mobile devices; and
adjust an allocation of transit resources based on the analysis.

16. The computer-readable medium m of claim 15, wherein the instructions further cause the one or more processors to:
lock in a journey cost for the selected route.

17. The computer-readable medium of claim 16, wherein:
the journey cost is valid for a predetermined time window about a selected journey start time.

18. The computer-readable medium of claim 15, wherein:
adjusting the allocation of transit resources comprises opening express lanes to a particular direction of traffic flow.

19. The computer-readable medium of claim 15, wherein the instructions further cause the one or more processors to:
notify the mobile device of a change in transit service status that impacts the selected route.

20. The computer-readable medium of claim 15, wherein the instructions further cause the one or more processors to:
receive location information associated with one or both of the mobile device and a vehicle associated with the mobile device; and
verify the that mobile device has completed a journey corresponding to the selected route based at least in part of the location information.
